(19) United States
(12) Patent Application Publication
(10) Pub. No.: US 2013/0174623 A1
(43) Pub. Date: Jul. 11, 2013

(54) CONDITIONED UREA-BASED GRANULAR FERTILIZERS AND METHODS OF MAKING THEREOF

(71) Applicant: Koch Agronomic Services, LLC., Wichita, KS (US)

(72) Inventor: Kurt D. Gabrielson, Lilburn, GA (US)

(73) Assignee: Koch Agronomic Services, LLC., Wichita, KS (US)

(21) Appl. No.: 13/711,534

(22) Filed: Dec. 11, 2012

Related U.S. Application Data
(60) Provisional application No. 61/569,398, filed on Dec. 12, 2011.

(51) Int. Cl. C05C 9/00

(52) U.S. Cl. CPC C05C 9/005
USPC 71/29; 71/28; 71/30

(57) ABSTRACT

The present invention provides methods for preparing flowable urea-based granular fertilizers, wherein the urea-based granular fertilizer has become wet; comprising contacting the urea-based granular fertilizer with a conditioner; and optionally other components to form a more flowable urea-base granular fertilizer. Methods for preventing urea-based granular fertilizer caking and urea-based granular fertilizer compositions are also disclosed.

### CROSS-REFERENCES TO RELATED APPLICATIONS

This application claims priority under 35 U.S.C. § 119(e) from U.S. Provisional Application 61/569,398 filed Dec. 12, 2011, which is incorporated by reference in its entirety herewith.

### BACKGROUND OF THE INVENTION

Granular fertilizers have been used for some time to provide nitrogen to the soil. The most widely used and agriculturally important nitrogen fertilizer is urea. Most of the urea currently produced is used as a fertilizer in its granular (or prilled) form. However granular solid urea is hygroscopic, which can result in stickiness, clumping and caking of the urea-based, granular fertilizer when the urea becomes wet. This reduces the flowability of urea-based granular fertilizers, and the like and complicates their handling. These complications can also arise when a urea-based granular fertilizer is stored in humid environments or the urea is in contact with water or a water-containing solution like most urea-based fertilizer additives.

Absorbent materials, such as attapulgite clay, diatomaceous earth and urea formaldehyde polymers (UFP) have been blended with granulated urea to prevent clumping and aid in the storage and handling of solid urea. However, there remains a need for methods of improving the flow of urea-based granular fertilizers that contain other components and either will be or have been exposed to water and/or high humidity. The invention as described herein addresses this and other needs.

### BRIEF SUMMARY OF THE INVENTION

In one aspect, the present invention provides a method for improving the flow of a urea-based granular fertilizer composition, wherein the urea has been exposed to an aqueous solution or high humidity; the method comprising contacting:

a) the urea-based granular fertilizer composition with

b) a conditioning agent;

wherein the conditioning agent improves the flow of the urea-based granular fertilizer.

In one aspect, the present invention provides a method for preventing caking of a urea-based granular fertilizer composition, the method comprising contacting:

a) the urea-based granular fertilizer composition with

b) a conditioning agent;

wherein the conditioning agent improves the flow of the urea-based granular fertilizer.

In another aspect, the present invention provides a granular fertilizer prepared by a method described herein.

### DETAILED DESCRIPTION OF THE INVENTION

Thus, in one group of embodiments, the present invention provides a method for improving the flow of a urea-based granular fertilizer composition, wherein the urea has been exposed to an aqueous solution or high humidity; the method comprising contacting:

a) the urea-based granular fertilizer composition with

b) a conditioning agent;

wherein the conditioning agent improves the flow of the urea-based granular fertilizer.

The urea-based granular fertilizer of the present invention can include any suitable quantity of a urea source and contains one or more additional components. In one group of embodiments, the urea source is granulated solid or prilled urea. One of skill in the art will appreciate other urea sources for the inventive methods. The amount of the urea source in the urea-based granular fertilizer can range from about 1% to about 99% by weight of the total granular fertilizer composition. The amount of the urea source in the urea-based granular fertilizer can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or about 99% by weight of the total granular fertilizer composition.

The urea-based granulated fertilizer of the present invention contains one or more additional components, for example, a enzyme inhibitor, such as a urease inhibitor; a nitrification inhibitor; a dye, such as blue dye (FD & C blue #1); a plant protectant; a nutrient stabilizer, a surfactant; an additional nitrogen source, such as ammonium nitrate; a conditioner; a micronutrient; a herbicide; a pesticide and/or combinations thereof; and is granulated.

Urease inhibitors are compounds capable of inhibiting the catalytic activity of the urease enzyme upon urea in moist soil. Examples of urease inhibitors include, but are not limited to, phosphoric triamides, such as N-(n-butyl)thiophosphoric triamide (NBPT) and the like.

Nitrification inhibitors are compounds which inhibit the conversion of ammonium to nitrate and reduce nitrogen losses in the soil. Examples of nitrification inhibitors include, but are not limited to, dicyandiamide (DCD), and the like.

Examples of plant protectants and nutrient stabilizers include silicon dioxide, and the like.

The content of the additional components can be from about 1 to about 99 percent by weight of the urea-based granular fertilizer. For example, the amount of the additional components in the urea-based granular fertilizer can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or about 94% by weight of the total granular fertilizer composition.

In one group of embodiments, the present invention provides a method, wherein the urea-based granular fertilizer composition comprises:
a) a urea source of from about 95% to 99% by weight of the total granular fertilizer composition;
b) a urease inhibitor, a nitrification inhibitor, or a combination thereof in the range of from about 1% to 5% by weight of the total granular fertilizer composition.

In one group of embodiments, the present invention provides a method wherein the urea-based granular fertilizer is a commercial fertilizer, including, but not limited to SUPER U®; UFLEXX®; UMAXX®; or granular urea treated with AGROTAIN DRY®.

The term “aqueous solution” as used throughout this specification refers not only to water in its pure form, but also to other solutions which comprise water, including other fertilizer additives. Accordingly, the aqueous solution may include one or more solvents besides water. Examples of solvents include glycols, including, but not limited to, propylene glycol, noncyclic diols, cyclic glycols, glycol derivatives, and the like; pyrolidines, including, but not limited to, 2-pyrrolidone, and N-alkyl 2-pyrrolidone; and amides, including, but not limited to, N,N-dimethylformamide. The co-solvent can be between about 99.9 percent by weight to about 0.1 percent by weight of the aqueous solution. Accordingly water content in the aqueous solution can also vary from between about 99.9% to about 0.1% by weight of the aqueous solution. The amount of water in the aqueous solution can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or about 99% by weight of the aqueous solution.

Commerical examples of aqueous solutions include, but not limited to AGROTAIN®, AGROTAIN ULTRA®, HYDREXX®, STA-FORM 60® and the like.

Accordingly, the water content in the urea-based granular fertilizer, which has been exposed to an aqueous solution or high humidity can vary. In one embodiment, the granular fertilizer composition comprises from about 0.01% to about 30% water by weight of the urea-based granular fertilizer. In another group of embodiments, the amount of the water in the urea-based granular fertilizer can be about 1, 2, 3, 4, 5, 6, 7, 8, 9, 10, 11, 12, 13, 14, 15, 16, 17, 18, 19, 20, 21, 22, 23, 24, 25, 26, 27, 28, 29 or about 30% by weight of the total granular fertilizer composition.

Thus in one embodiment, the present invention provides a method, wherein the aqueous solution further comprises:
i) from about 70 to about 80 weight % of a solvent selected from the group consisting of N-methyl pyrrolidone, propylene glycol, and combinations thereof in an amount of from about 70% to about 80 weight % of the total weight of the non-water components of the aqueous solution; and
ii) a urease inhibitor, a nitrification inhibitor; or combinations thereof in an amount of from about 20% to about 30 weight % of the total weight of the non-water components of the aqueous solution.

The term “high humidity” refers to at least about 70% relative humidity (70% RH).

In one group of embodiments, the conditioner comprises one or more components selected from the group consisting of urea formaldehyde polymer (UFP), a polymethyl urea resin, tricalcium phosphate, sodium bicarbonate, sodium ferricyanide, potassium ferricyanide, bone phosphate, sodium silicate, silicon dioxide, calcium silicate, talcum powder, bentonite, calcium aluminum silicate, stearic acid, and polyacrylate powder.

In another group of embodiments, the conditioner is UFP. UFP may be a polymethyl urea resin with approximately 0.6% reactive methylol groups. It has primary particles of 0.1 to 0.15 micrometers, forming agglomerates of 3.5 to 6.5 micrometers diameter on average. In one group of embodiments, the UFP is PERGOPAK M® 2, a trademark of Albemarle Corporation. Alternatively, the UFP is the unrefined precursor to PERGOPAK M® 2, sometimes referred to as “the filter cake”.

In another group of embodments, the conditioner optionally contains a dust control agent, including but not limited to mineral oil, and the like. In another group of embodiments, the conditioner and dust control agent are used in a single composition which comprises about 1% by weight of a dust control agent.

The conditioner content used with the urea-based fertilizer can vary as described herein. Based on the dry weight of the conditioner, the condition is used in the range of about from 0.01 to about 0.5% by weight of the granular fertilizer composition. The amount of the conditioner used on the urea-based granular fertilizer can be about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 10.9, 0.2, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0. 0.48, 0.49 or about 0.5% by weight of the total granular fertilizer composition. In another group of embodiments, the ratio of conditioner to granular fertilizer used is from about 1:5000 to 3:1000.

If the filter cake is used, greater amounts by weight must be used to achieve the desired results, because of the higher water content of the UFP filter cake. The UFP can be added to the urea prior to granulation of the urea.

In one aspect, the present invention provides a method, wherein the contacting is selected from the group consisting of blending and mixing. The conditioner when mixed or blended with a urea-based fertilizer provides a urea-based fertilizer that has improved storage and handling properties.

The granular fertilizer composition of this invention made by the methods described herein can be used in all agricultural applications in which granular fertilizer compositions are currently used. These applications include a very wide range of crop and turf species, tillage systems, and fertilizer placement methods.

The following examples are intended to illustrate, but not to limit, the methods and compositions of the invention. All percentages described herein are by weight, unless otherwise indicated.

### EXAMPLE 1

A conditioner is prepared by blending 1% by weight mineral oil with 99% by weight PERGOPAK M.

### EXAMPLE 2

2.5 pounds of PERGOPAK M or the conditioner from Example 1 is combined with 1 ton of SUPER U fertilizer, previously stored at least about 70% RH and ambient temperature. The SUPER U does not flow freely during initial handling. The conditioner and fertilizer are mixed in a blender until the fertilizer/conditioner mixture is observed to flow freely.

### EXAMPLE 3

2.5 pounds of PERGOPAK M or the conditioner from Example 1 is combined with 1 ton of SUPER U fertilizer. The conditioner and fertilizer are mixed in a blender. The composition is then stored at least about 70% RH and ambient temperature for 1 day. The SUPER U flows freely after being stored in 70% or more RH for 1 day.

### EXAMPLE 4

Granulated urea is treated with a solution of AGROTAIN. 2.5 pounds of PERGOPAK M or the conditioner from Example 1 are combined with 1 ton of the AGROTAIN treated urea. The conditioner and AGROTAIN treated urea are mixed in a blender until the fertilizer/conditioner mixture is observed to flow freely flowly. The conditioned urea-based fertilizer is used directly or is stored in at least about 70% RH and ambient temperature for 1 day. The conditioned fertilizer flows freely after being stored in 70% or more RH for 1 day.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A method for improving the flow of a urea-based granular fertilizer composition, wherein the urea-based granular fertilizer has been exposed to an aqueous solution or high humidity; the method comprising contacting:
a) the urea-based granular fertilizer composition with
b) a conditioning agent.

2. A method for preventing caking a urea-based granular fertilizer composition, the method comprising contacting:
a) the urea-based granular fertilizer composition with
b) a conditioning agent.

3. A method according to claim 1, wherein the urea-based granular fertilizer composition comprises:
a) a urea source of from about 5% to 95% by weight of the total granular fertilizer composition;
b) a urease inhibitor, a nitrification inhibitor, or a combination thereof in the range of from about 5% to 95% by weight of the total granular fertilizer composition.

4. A method according to claim 1, wherein the aqueous solution further comprises:
i) a solvent selected from the group consisting of N-methyl pyrrolidone, propylene glycol, or combinations thereof; and
ii) one or more components selected from the group consisting of:
a. a urease inhibitor, and
b. a nitrification inhibitor.

5. A method according to claim 1, wherein the urease inhibitor or nitrification inhibitor is (n-butyl)thiophosphoric triamide (NBPT).

6. A method according to claim 1, wherein the urea-based granular fertilizer composition that has been exposed to an aqueous solution or high humidity comprises 0.01% to about 30% water by weight.

7. A method according to claim 1, wherein the conditioner comprises one or more components selected from the group consisting of urea formaldehyde polymer, a polymethyl urea resin, tricalcium phosphate, sodium bicarbonate, sodium ferricyanide, potassium ferricyanide, bone phosphate, sodium silicate, silicon dioxide, calcium silicate, talcum powder, bentonite, calcium aluminum silicate, stearic acid, and polyacrylate powder.

8. A method according to claim 1, wherein the conditioning agent is a urea-formaldehyde polymer.

9. A method according to claim 1, wherein the conditioning agent is a polymethyl urea resin.

10. A method according to claim 1, wherein the polymethyl urea resin is PERGOPAK M.

11. A method according to claim 1, wherein the conditioner is present in the amount of about 0.01 to about 0.5 weight % of the urea-based granular fertilizer composition.

12. A method according to claim 1, wherein the ratio of conditioner to granular fertilizer used is from about 1:5000 to 3:1000.

13. A method according to claim 1, wherein the conditioner is used with a dust control agent.

14. A method according to claim 13, wherein the conditioner and dust control agent are used in a single composition which comprises about 1% by weight of the dust control agent.

15. A method according to claim 13, wherein the dust control agent is mineral oil.

16. A method according to claim 1, wherein the contacting is selected from the group consisting of blending and mixing.

17. A granular fertilizer prepared by the method of claim 1.
